(19) United States
(12) Patent Application Publication
(10) Pub. No.: US 2023/0168885 A1
(43) Pub. Date: Jun. 1, 2023

(54) SEMANTICALLY DRIVEN DOCUMENT STRUCTURE RECOGNITION

(71) Applicant: Palo Alto Research Center Incorporated, Palo Alto, CA (US)

(72) Inventors: Gregory Michael Youngblood, Las Cruces, NM (US); Robert Thomas Krivacic, San Jose, CA (US); Jacob Le, Palo Alto, CA (US)

(21) Appl. No.: 17/538,535

(22) Filed: Nov. 30, 2021

(51) Int. Cl. G06F 8/73; G06F 16/23

(52) U.S. Cl. CPC G06F 8/73; G06F 16/2379

(57) ABSTRACT

A method comprises receiving a user model from a database for a particular user while the user is creating code, the user model comprising information about the particular user. The method comprises initiating engagement with the user based on the user model and at least one knowledge base trigger, and receiving a response from the user based on the initiated engagement. The method also comprises establishing an exchange with the user based on the user response, converting the exchange into code comments, and inserting the code comments into the code. The method further comprises updating the user model based on the exchange, and storing the updated user model in the database.

### TECHNICAL FIELD

The present disclosure is generally directed to software documentation.

### SUMMARY

Some embodiments are directed to a method comprising receiving a user model from a database for a particular user while the user is creating code, the user model comprising information about the particular user. The method comprises initiating engagement with the user based on the user model and at least one knowledge base trigger, and receiving a response from the user based on the initiated engagement. The method also comprises establishing an exchange with the user based on the user response, converting the exchange into code comments, and inserting the code comments into the code. The method further comprises updating the user model based on the exchange, and storing the updated user model in the database.

Some embodiments are directed to a system comprising a processor and a database configured to store one or more user models. The system also comprises a memory storing computer program instructions which, when executed by the processor, cause the processor to perform operations comprising receiving a user model from the database for a particular user while the user is creating code, the user model comprising information about the particular user, initiating engagement with the user based on the user model and at least one knowledge base trigger, receiving a response from the user based on the initiated engagement, establishing an exchange with the user based on the user response, converting the exchange into code comments, inserting the code comments into the code, updating the user model based on the exchange, and storing the updated user model in the database.

Some embodiments are directed to a non-transitory computer readable medium storing computer program instructions The computer program instructions, when executed by a processor, cause the processor to perform operations comprising receiving a user model from a database for a particular user while the user is creating code, the user model comprising information about the particular user, initiating engagement with the user based on the user model and at least one knowledge base trigger, receiving a response from the user based on the initiated engagement, establishing an exchange with the user based on the user response, converting the exchange into code comments, inserting the code comments into the code, updating the user model based on the exchange, and storing the updated user model in the database.

### BRIEF DESCRIPTION OF THE DRAWINGS

FIG. 1 illustrates a process for guiding software documentation in accordance with embodiments described herein.

FIG. 2 shows a block diagram of a system capable of implementing embodiments described herein;

FIG. 3 an example of using psychological triggers that help the user develop intentions and then follow desirable behaviors in accordance with embodiments described herein;

FIG. 4 illustrates an architecture for guiding software documentation in accordance with embodiments described herein;

FIG. 5 illustrates a process for engaging a code writing user in order to improve code comments of the programming language in use in accordance with embodiments described herein; and

FIG. 6 shows an example of how to implement a system for guiding software documentation in accordance with embodiments described herein.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

Machines execute code, but humans maintain, debug, and update it. Unfortunately, despite notions of developers becoming more literate programmers in which the languages and ways that we write programs become better at explaining to human beings what we want a computer to do, the reality is that programs and developers aim mostly at computer execution. Despite maturity as a discipline and decades of promoting better code documentation, it is one of the most neglected process issues within software engineering. With the current broad adoption of agile programming methodologies, the drive to a minimum viable product (MVP) exacerbates the technical debt issue of proper and meaningful documentation. Documenting code is time consuming and often difficult because there is a lack of importance (e.g., documentation does not execute in an MVP), it is not well-developed as a coding behavior, and without a driving questioner it can be difficult to do from scratch and may be a form of writer's block or even analysis paralysis.

Embodiments described herein involve a system and a method for engaging a code writing user (i.e., developer) in order to improve the recording of intent, context, and/or other pertinent materials in the code comments of the programming language in use. This approach is programming language agnostic and may or may not include a psychology basis in the questions leading to better coding documentation as planned behavior.

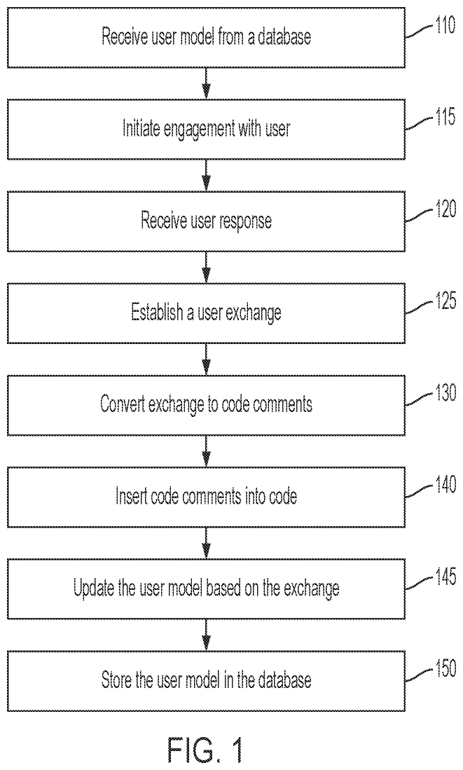

FIG. 1 illustrates a process for guiding software documentation in accordance with embodiments described herein. The process shown in FIG. 1 involves receiving 110 a user model from a database for a particular user while the user is creating code. The user model comprises information about the particular user. The process involves initiating engagement 115 with the user based on the user model and at least one knowledge base trigger, and receiving 120 a response from the user based on the initiated engagement. The process also involves establishing 125 an exchange with the user based on the user response, converting 130 the exchange into code comments, and inserting 140 the code comments into the code. The process further involves updating 145 the user model based on the exchange, and storing 150 the updated user model in the database.

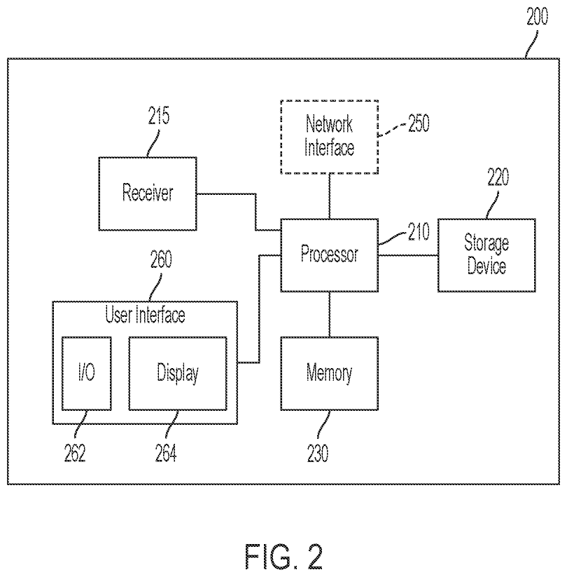

The methods described herein can be implemented on a computer using well-known computer processors, memory units, storage devices, computer software, and other components. A high-level block diagram of such a computer is illustrated in FIG. 2. Computer 200 contains a processor 210, which controls the overall operation of the computer 200 by executing computer program instructions which define such operation. The computer program instructions may be stored in a storage device 220 (e.g., magnetic disk) and loaded into memory 230 when execution of the computer program instructions is desired. Thus, the steps of the methods described herein may be defined by the computer program instructions stored in the memory 230 and controlled by the processor 210 executing the computer program instructions. It is to be understood that the processor 210 can include any type of device capable of executing instructions. For example, the processor 210 may include one or more of a central processing unit (CPU), a graphical processing unit (GPU), a field-programmable gate array (FPGA), and an application-specific integrated circuit (ASIC).

The computer 200 may include one or more network interfaces 250 for communicating with other devices via a network. The computer 200 also includes a user interface 260 that enable user interaction with the computer 200. The user interface 260 may include I/O devices 262 (e.g., keyboard, mouse, speakers, buttons, etc.) to allow the user to interact with the computer. Such input/output devices 262 may be used in conjunction with a set of computer programs for guiding software documentation in accordance with embodiments described herein. The user interface may include a display 264. The computer may also include a receiver 215 configured to receive data from the user interface 260 and/or from the storage device 220. According to various embodiments, FIG. 2 is a high-level representation of possible components of a computer for illustrative purposes and the computer may contain other components.

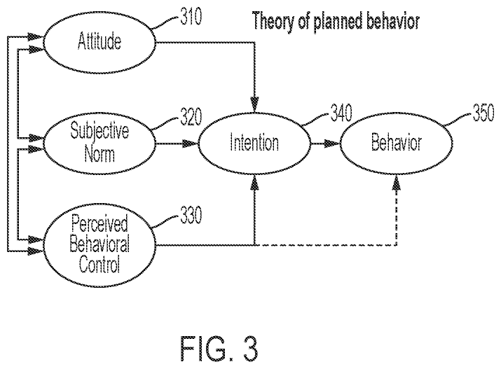

Embodiments described herein involve using an artificial coach that helps the user 1) to build self-efficacy by agreeing to and engaging in the code documentation process and/or 2) developing code documentation through code analysis, user modeling, and/or knowledge base triggers leading to questions and engagements that in a piece wise fashion develop the comments. This knowledge base may include psychological triggers that help the user develop intentions and then follow desirable behaviors as shown in FIG. 3. The theory, reinforced by decades of research and thousands of studies, establishes that planned behavior comes from a formed intention 340 of that behavior, which in turn is induced by a positive attitude 310 towards doing that behavior (i.e., the person believes that it is a proper or good thing to do), a belief system or subjective norm 320 that supports such behavior (e.g., learned through family, tribe, or culture as a proper or good thing to do), and the “perceived behavior control” 330 or “self-efficacy,” which means that the user believes that they can actually perform the behavior 350.

Attitude and belief systems are difficult to induce, although many development shops do have a culture of good code documentation. However, self-efficacy holds a special position of power in the theory as that it alone can be the driver of behavior—as indicated by the dashed line in FIG. 3. A database of questions such as “Can you edit to make any corrections?” or “Can you add more information?” posed as simple yes or no questions can be used to gain a positive action in taking the appropriate sized step to get the user going. This may lead to building intention and planned behavior, which in this case is better code documentation. Other question sets define trigger pre-conditions, dependencies (for sequences of questions), and account for user model preferences and observed behaviors to engage the user in questions for more complete and meaningful code documentation. The system monitors the code documents and uses code analysis tools such as keyword usage and other static analysis tools to establish state elements that serve as triggers for questioning engagements. Question sets may lead to producing many types of documentation artifacts such as descriptions, models, graphics, and so forth. The questions may guide the user to creating the desired documentation content. An example question set may guide the user to produce diagrams and/or a UML model which allows images to be created through text.

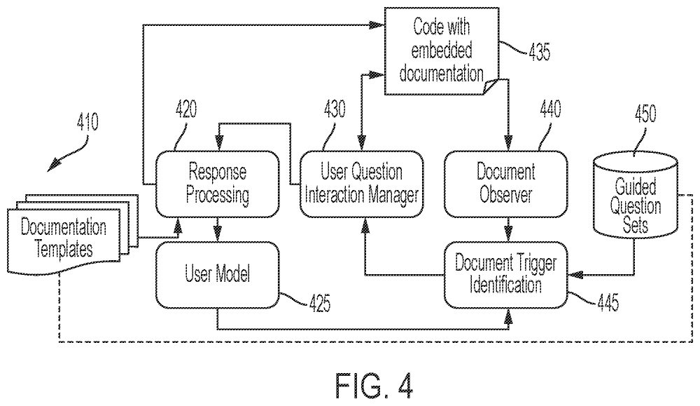

According to embodiments described herein, A database of questions 450 that guide the user and contains defined triggers, as appropriate for the desired documentation, may be curated by the organization providing coding and documentation standards. Self-efficacy questions and triggers can be defined by hierarchical decomposition of code documentation tasks using difficulty and composition as the organizing metrics. Users can be asked if they feel that they can accomplish a task, if not, ask for an easier task in the hierarchy until they agree, then start building the user's confidence to complete harder tasks, moving upward on the task tree until completion. A good hierarchical task tree would have smooth and logical difficulty transitions up, down, and laterally. This task network information is embedded into the questions sets. The artificial coach uses this question database, labeled as “Guided Question Sets,” and is created through the architecture shown in FIG. 4.

The system centers around the code with embedded documentation 435, which is standard for all programming languages. The Document Observer module 440 tracks the changes being made in the code and looks for the presence of a defined set of triggers. These trigger conditions may be identified by a set of one or more existing or defined pattern recognizers that looks for keywords, structures, artifacts (i.e., file includes), software engineering metrics (e.g., cyclomatic complexity), and/or other measurable and/or identifiable characteristics in the code text. Identified triggers are communicated to the Document Trigger Identification module 445.

According to various embodiments, the Document Observer module 440 is configured to find and/or learn what areas of the code are complex or hard to understand. This may allow the Document Observer module 440 to mark areas of the code that might be important during code reviews. The code analysis could also include tests for unsafe and/or forbidden practices as defined by the governing organization of the particular jurisdiction that the user is located in.

The Document Trigger Identification module 445 references the Guided Question Sets database 450 for questions with matching trigger conditions and creates a queue of questions. Queue ordering may be resolved by metadata, preference selection techniques, dependency data, and/or other order resolution schemes.

Preferences, avoidances, stylization (e.g., user's name embedding) and other user-aware customizations may come from pulling User Model 425 information. The question queue is communicated to the User Question Interaction Manager module to be interactively posed and an answer recorded to/from the user and/or developer.

The User Question Interaction Manager module 430 manages the presentation and interaction of questions and receipt of answers with the user/developer. According to various configurations, the User Question Interaction Manager module 430 the makes the ultimate decisions on how, when, and/or what order the questions are posed. Answers may be communicated to the Response Processing module 420.

The Response Processing module 420 receives data about the question posed, answer received, and pulls documentation template data 410 associated with the documentation questions in order to format and synthesize the information into embedded documentation. According to various embodiments, the Response Processing Module 420 then inserts the documentation directly into the code document. If it needs to communicate state information back so that additional questions are asked, it does this through the User Model module 425.

The User Model module 425 keeps track of the user's state, preferences, and/or the code documentation process. According to various embodiments, the User Model module 425 provides information to the Document Trigger Identification module 445 that helps customize questions and/or interactions. The User Model module 425 may provide trigger conditions directly to the Document Trigger Identification module 445, which may invoke new user interactions through the User Question Interaction Manager module 430 (e.g., asking the user for additional information and/or to double check generated documentation when there is uncertainty in the generation process). The User Model 425 may be generated anew each use and/or stored for each user. The user model may be generic for all users, specific for each user, or mixed.

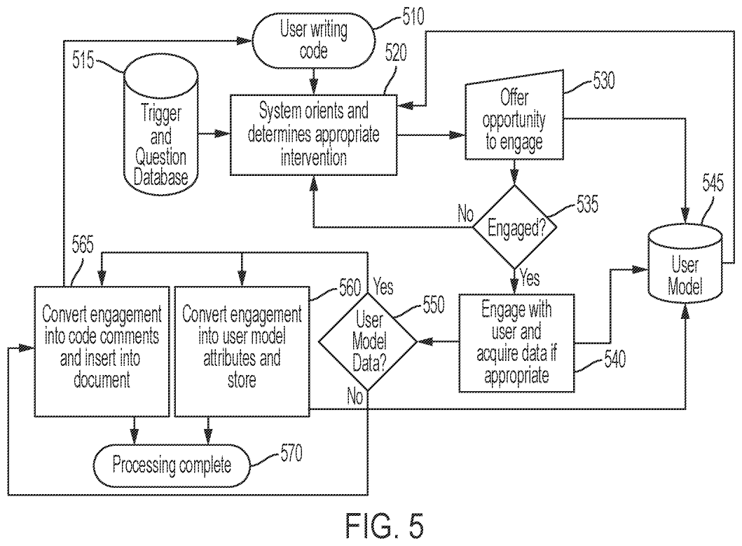

FIG. 5 illustrates a process for engaging a code writing user (i.e., developer) in order to improve code comments of the programming language in use in accordance with embodiments described herein. The process described in conjunction with FIG. 5 may use the same or similar architecture and/or components shown in FIG. 4. In some cases, the process of FIG. 5 uses a different architecture than that shown in FIG. 4.

A user model 545 based on a particular user 510 writing the code is used to orient the system and determine an appropriate intervention 520 along with a trigger and question database 515. The user model 545 may be based on previous interactions and/or learned behavior from the particular user 510. In some cases, the user model 545 may be based on previous code samples for the particular user. For example, the user model 545 may be learned using previous code samples from the user 510 as a training data set using machine learning.

According to various configurations, the user model 545 is based on a default user model. There may be more than one default user model. For example, the particular default user model may vary based on particular demographics of the user (e.g., age, geographic location, language, experience, etc.).

The user is given the opportunity to engage 530 with the system. Based on the user response to the opportunity to engage, the user model 545 may be updated for the particular user 510. It is determined 535 if the user 510 has decided to engage with the system. If it is determined 535 that the user 510 has decided not to engage, the system may again orient and determine an appropriate intervention 520. The intervention may include offering an opportunity to engage in a different way. In some cases, the system may determine that the user is not going to engage and end the process without creating any code comments. If it is determined 535 that the user is engaged, the system engages 540 with the user 510 and acquires data, if appropriate. The data may include information about the code that is being written by the user and/or information about the user 510, for example. The collected information may be used to update the user model 545.

It is determined 550 whether there is a user model data for the particular user 510. If it is determined 550 that there is no user model data for the particular user 510, the engagement is converted into code comments and the code comments are inserted 565 into the document and the process ends 570. If it is determined that there is user model data for the particular user 510 the engagement is converted 560 into user model attributes and stored and/or the engagement is converted 565 to code comments that are inserted into the document and the process completes 570. According to various embodiments, the engagement session may be used to update the user model 545 for the particular user 510.

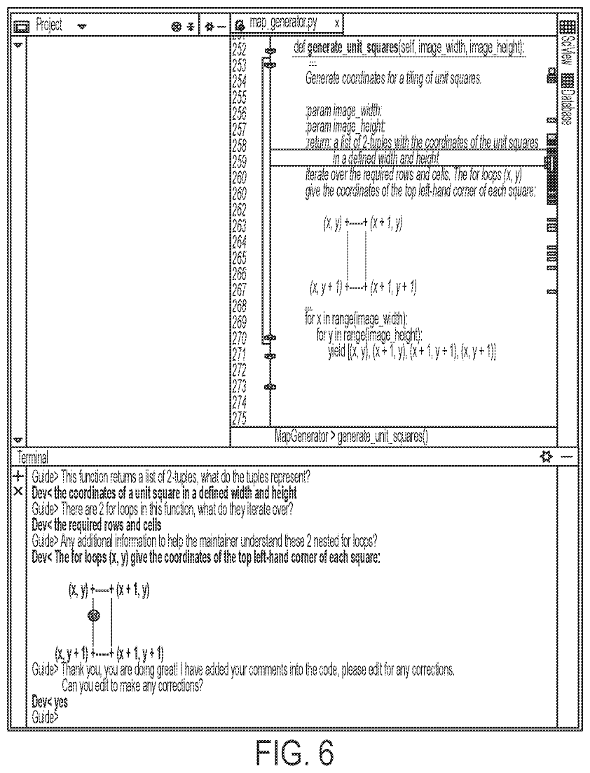

FIG. 6 shows an example of how to implement the system described herein. In this example, the code documentation coach, or “Guide” in this instance, is an independent program executed and interacting through text in a terminal shell embedded in a code Integrated Development Environment (IDE). Code additions and/or changes made on the file system are automatically reflected in the IDE. This agent could be executed in a separate, not integrated, terminal shell. In some cases, the agent could be a module of the IDE itself. According to various embodiments, the agent could also be a web server working through a shared code repository, for example. Embodiments can be passive, waiting for user interaction, or aggressive, blocking the user until they engage completely, or anywhere in between.

According to various embodiments described herein, the system may retain metadata at one or more engagement points and score the user on the engagement. This data could then be used to point out areas of inspection during code reviews, which in turn could be tracked to determine the order and priority in which identifiable and measured areas should be brought to organizational attention. According to various configurations, the engagement score may be used to update the user model.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g. 1 to 5 includes 1, 1.5, 2, 2.75, 3, 3.80, 4, and 5) and any range within that range.

The various embodiments described above may be implemented using circuitry and/or software modules that interact to provide particular results. One of skill in the computing arts can readily implement such described functionality, either at a modular level or as a whole, using knowledge generally known in the art. For example, the flowcharts illustrated herein may be used to create computer-readable instructions/code for execution by a processor. Such instructions may be stored on a computer-readable medium and transferred to the processor for execution as is known in the art. The structures and procedures shown above are only a representative example of embodiments that can be used to guide software documentation as described above.

The foregoing description of the example embodiments have been presented for the purposes of illustration and description. It is not intended to be exhaustive or to limit the inventive concepts to the precise form disclosed. Many modifications and variations are possible in light of the above teachings. Any or all features of the disclosed embodiments can be applied individually or in any combination, not meant to be limiting but purely illustrative. It is intended that the scope be limited by the claims appended herein and not with the detailed description.

What is claimed is:

1. A method comprising:
receiving a user model from a database for a particular user while the user is creating code, the user model comprising information about the particular user;
initiating engagement with the user based on the user model and at least one knowledge base trigger;
receiving a response from the user based on the initiated engagement;
establishing an exchange with the user based on the user response;
converting the exchange into code comments;
inserting the code comments into the code;
updating the user model based on the exchange; and
storing the updated user model in the database.

2. The method of claim 1, wherein the user model is learned from past interactions with the user.

3. The method of claim 1, wherein the user model is based on demographic information about the user.

4. The method of claim 1, further comprising:
receiving at least one code sample of the user; and
updating the user model based on the at least one code sample.

5. The method of claim 1, further comprising receiving a plurality of possible questions to be asked to the user during the exchange from a question database.

6. The method of claim 1, further comprising tracking changes being made in the code.

7. The method of claim 6, further comprising:
searching for presence of one or more trigger conditions while tracking changes being made in the code;
searching for questions with matching trigger conditions; and
creating a queue of questions to be posed to the user.

8. The method of claim 7, wherein searching for presence of one or more trigger conditions comprises searching for presence of one or more trigger conditions based on one or more of keywords, structures, artifacts, and software engineering metrics.

9. A system, comprising:
a processor;
a database configured to store one or more user models; and
a memory storing computer program instructions which when executed by the processor cause the processor to perform operations comprising:
receiving a user model from the database for a particular user while the user is creating code, the user model comprising information about the particular user;
initiating engagement with the user based on the user model and at least one knowledge base trigger;
receiving a response from the user based on the initiated engagement;
establishing an exchange with the user based on the user response;
converting the exchange into code comments;
inserting the code comments into the code;
updating the user model based on the exchange; and
storing the updated user model in the database.

10. The system of claim 9, wherein the user model is learned from past interactions with the user.

11. The system of claim 9, wherein the user model is based on demographic information about the user.

12. The system of claim 9, wherein the processor is further configured to:
receive at least one code sample of the user; and
update the user model based on the at least one code sample.

13. The system of claim 9, wherein the processor is further configured to receive a plurality of possible questions to be asked to the user during the exchange from a question database.

14. The system of claim 9, wherein the processor is further configured to track changes being made in the code.

15. The system of claim 14, wherein the processor is further configured to:
search for presence of one or more trigger conditions while tracking changes being made in the code;
search for questions with matching trigger conditions; and
create a queue of questions to be posed to the user.

16. The system of claim 15, wherein the processor is further configured to determine one or more trigger conditions based on one or more of keywords, structures, artifacts, and software engineering metrics.

17. A non-transitory computer readable medium storing computer program instructions, the computer program instructions when executed by a processor cause the processor to perform operations comprising:
receiving a user model from a database for a particular user while the user is creating code, the user model comprising information about the particular user;
initiating engagement with the user based on the user model and at least one knowledge base trigger;
receiving a response from the user based on the initiated engagement;
establishing an exchange with the user based on the user response;
converting the exchange into code comments;
inserting the code comments into the code;
updating the user model based on the exchange; and
storing the updated user model in the database.

18. The non-transitory computer readable medium of claim 17, wherein the user model is learned from past interactions with the user.

19. The non-transitory computer readable medium of claim 17, wherein the user model is based on demographic information about the user.

20. The non-transitory computer readable medium of claim 17, further comprising receiving a plurality of possible questions to be asked to the user during the exchange from a question database.
